(19) United States
(12) Patent Application Publication
(10) Pub. No.: US 2023/0147228 A1
(43) Pub. Date: May 11, 2023

(54) SYSTEMS AND METHODS FOR IMPROVED TRANSACTION PLATFORMS

(71) Applicant: Cox Automotive, Inc., Atlanta, GA (US)

(72) Inventors: Mazen Letayf, Atlanta, GA (US); Rahul Gupta, Atlanta, GA (US); Vishal Gaur, Atlanta, GA (US)

(73) Assignee: Cox Automotive, Inc., Atlanta, GA (US)

(21) Appl. No.: 18/052,394

(22) Filed: Nov. 3, 2022

Related U.S. Application Data
(60) Provisional application No. 63/276,016, filed on Nov. 5, 2021.

(51) Int. Cl. G06Q 30/06; G06Q 30/02; G06Q 20/24

(52) U.S. Cl. CPC G06Q 30/0623; G06Q 30/0283; G06Q 20/24

(57) ABSTRACT

This disclosure describes systems and methods for improved transaction platforms. An example method may include receiving, by a processor and from a user, a selection of a first vehicle from a user interface. The example method may also include determining, by the processor and based on the first vehicle, a second vehicle. The example method may also include sending, by the processor, data associated with the first vehicle and data associated with the second vehicle to one or more entities. The example method may also include receiving, by the processor, first payment information for the first vehicle and second payment information for the second vehicle. The example method may also include determining, by the processor and based on the first payment information and the second payment information, third payment information for a third vehicle. The example method may also include causing to present, by the processor, the first payment information, the second payment information, and the third payment information on the user interface.

### CROSS-REFERENCE TO RELATED PATENT APPLICATION

The present application is related to and claims priority from Provisional Application No. 63/276,016 filed on Nov. 5, 2021 titled “SYSTEMS AND METHODS FOR IMPROVED TRANSACTION PLATFORMS.”

### BACKGROUND

Some conventional transaction platforms provide a user with the capability to browse item listings for purchase (for example, through a website, application, or the like). These platforms may also provide the user the ability to determine estimated payment information (for example, a monthly payment amount) associated with a particular item that the user may be potentially interested in purchasing through financing. However, for every item the user desires to obtain this estimated payment information, they may be required to manually input information such as a desired financing structure (term length, down payment, etc.). Additionally, this payment information may only provide estimated payment information, and may not accurately reflect the actual payment amount that is specific to the user. This may lead to inefficiencies for the user in browsing for such items and may require more manual data input on the user's part in order for the user to make an informed decision about a purchase. Additional difficulties may also arise when the user is unable to obtain traditional financing (for example, if the user has no credit score or a subprime credit score).

### BRIEF DESCRIPTION OF THE DRAWINGS

FIG. 1 depicts an illustrative schematic diagram of an example system, in accordance with one or more example embodiments of the present disclosure.

FIGS. 2A-2D depict illustrative flow diagrams, in accordance with one or more example embodiments of the present disclosure.

FIG. 2E depicts example selection criteria for a representative group of vehicles, in accordance with one or more example embodiments of the present disclosure.

FIGS. 3-4 depict illustrative user interface(s), in accordance with one or more example embodiments of the present disclosure.

FIG. 5 depicts an illustrative method, in accordance with one or more example embodiments of the present disclosure.

FIG. 6 depicts a block diagram of an example machine upon which any of one or more techniques (e.g., methods) may be performed, in accordance with one or more example embodiments of the present disclosure.

### DETAILED DESCRIPTION

Example embodiments described herein provide certain systems and methods for improved transaction platforms. The term “transaction platform” as used herein may refer to a system that a user may access to facilitate the purchase or sale of an item. An example of such a “transaction platform” includes a vehicle purchase/sale platform. Although reference may be made herein to a transaction platform involving the purchase and/or sale of vehicles, the systems and methods described herein may similarly be applied to any other type of product or service that may be purchased using financing. In some cases, conventional transaction platforms may be associated with a user interface that allows a user to browse a listing of the different items and select an item for purchase. The user may also be able to view information about the item, such as descriptive information. The user may also be able to obtain estimated recurring payment information if the user desires to finance the particular item.

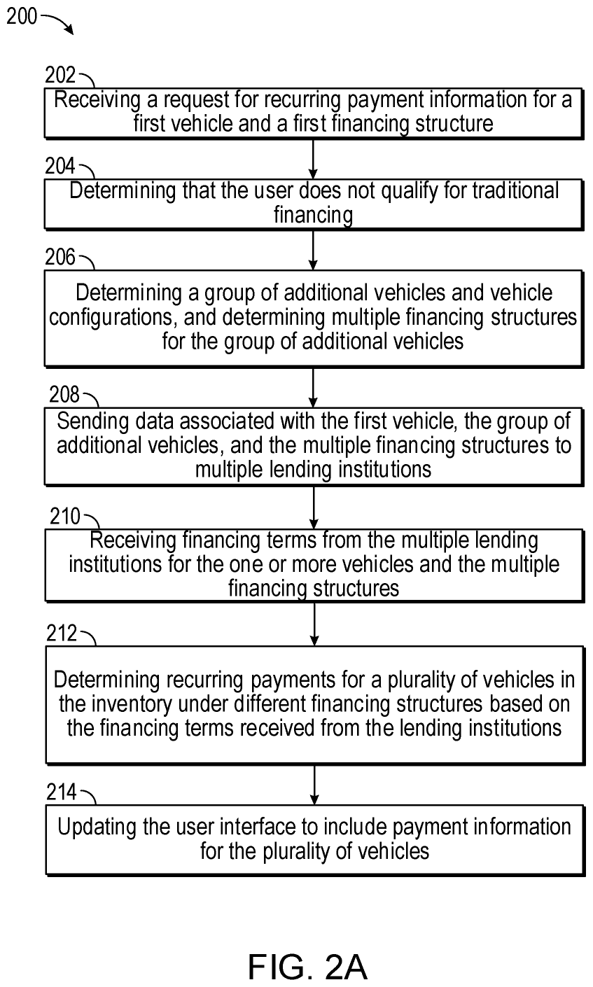

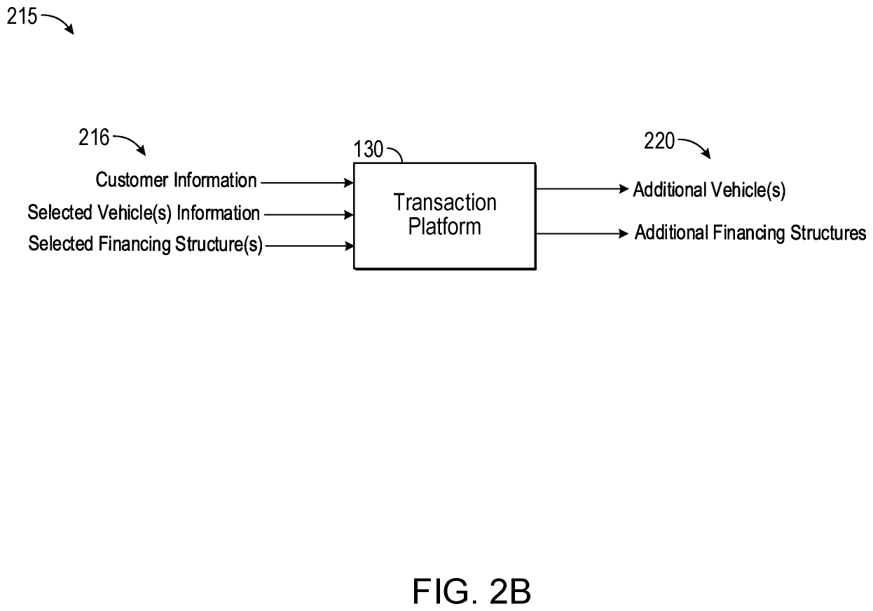

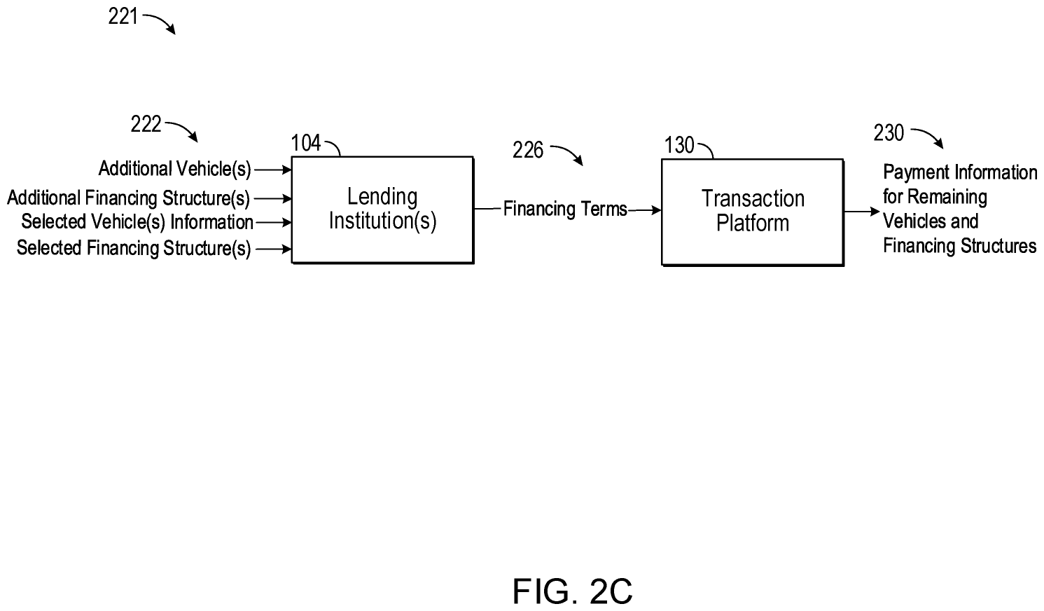

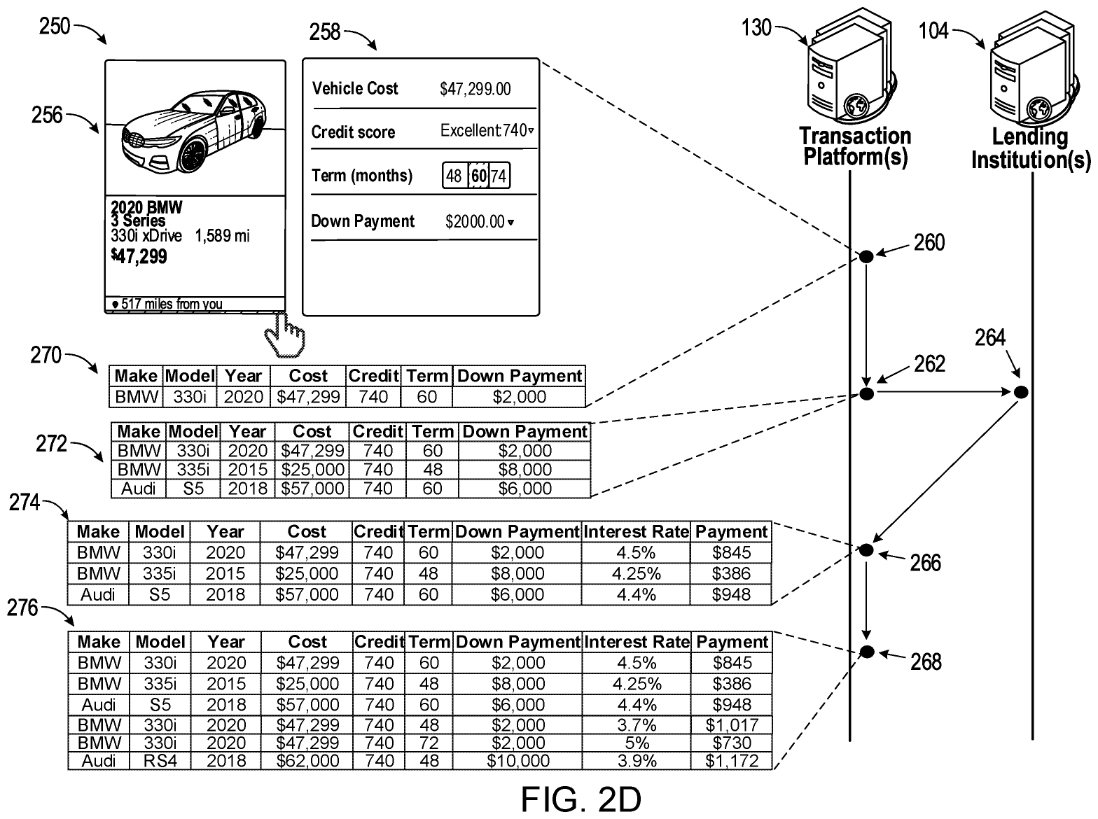

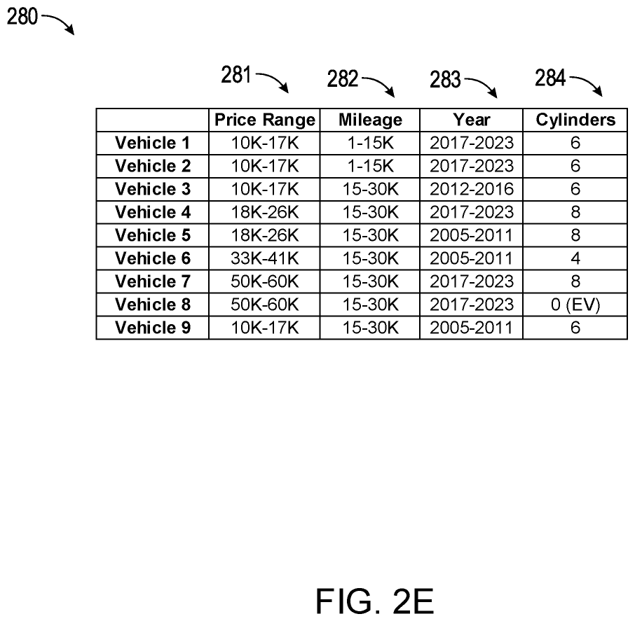

The systems and methods described herein improve upon conventional transaction platforms by allowing for, in some instances, exact recurring payment information, and in some other instances, personalized recurring payment information for an entire vehicle inventory (or a subset of vehicles included in the inventory) to be determined and presented to a user (if the transaction platform involves the sale and/or purchase of vehicles) while requiring minimal to no manual data input by the user. Exact payment information refers to payment information received from lender for a user. Personalized recurring payment may refer to payment information for a particular user calculated by systems and methods described herein. Additionally, recurring payment information may be provided for not only the entire vehicle inventory, but also for different types of possible financing structures that a user may select from (for example, different term lengths, down payments, etc.). Furthermore, the payment information may be determined and presented even if the user has a subprime credit score or has not met eligibility criteria from a retailer. Conventional transaction platforms may allow a user to obtain estimated recurring payment information for vehicles, but may require the user to manually request such information for each vehicle and financing structure combination for which they desire to obtain this information. This may be overly time-consuming for the user and may result in a poor shopping experience for the user. An alternative option may be for the system to determine estimated payment information for all combinations of vehicles, vehicle configurations, and financing structures that are possible based on the vehicle inventory. However, the amount of time required to perform these computations would be unfeasible. To put these computational requirements in perspective, pre-calculating estimated payment amounts for a vehicle inventory including 5,000 vehicles with 100 down payment options, 3500 net trade-in options, five payment term options, six tiers, and 50,000 tax locations may result in 2.625 trillion total calculations required to build a cache to sustain all of these pontifical combinations. Assuming conventional APIs may be able to perform 50 calculations per second, it would take over 13 million days to calculate all of the possible permutations. Additionally, an extra layer of difficulty is added to these determinations if the user has no credit score or if the user has a subprime credit score. To address this, the systems and methods described herein may eliminate or limit the need for these manual determinations and allow for personalized payment information to be automatically computed and presented to a user in a practical amount of time (in some cases, in real-time) that allows the user to view such information as they browse the vehicle inventory through the user interface. This also allows a user to more efficiently browse the vehicle inventory and make potential purchasing decisions without requiring the user to manually request payment information, and even if the user has a subprime credit score. Additional details regarding the operations associated with these systems and methods may be described below with respect to at least FIGS. 2A-2E.

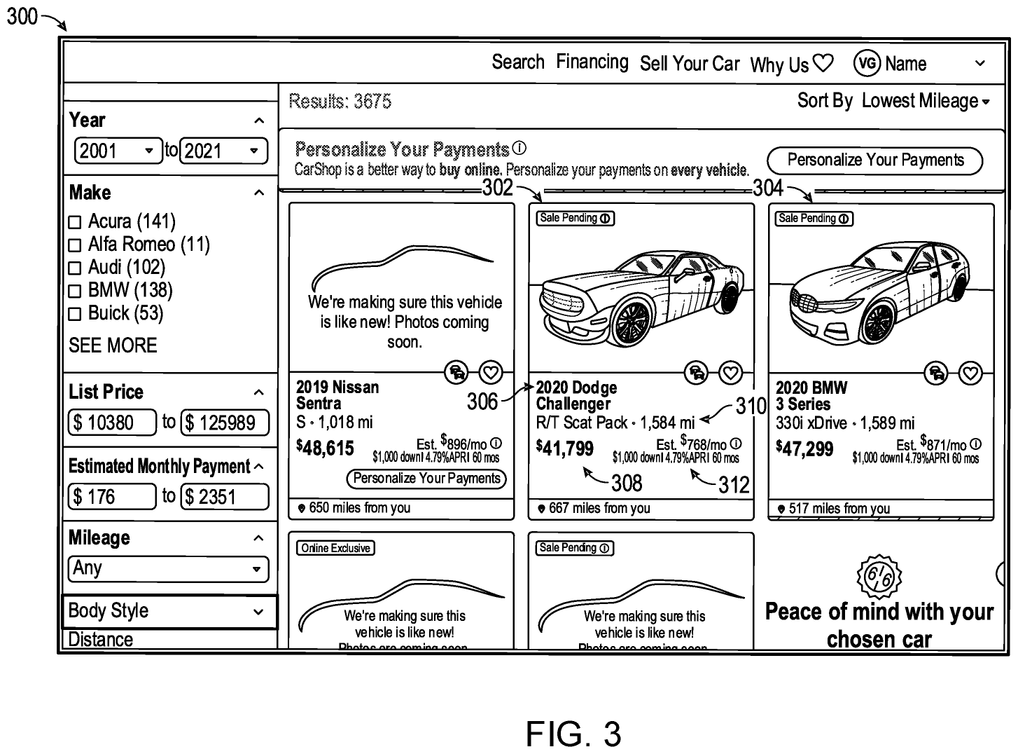

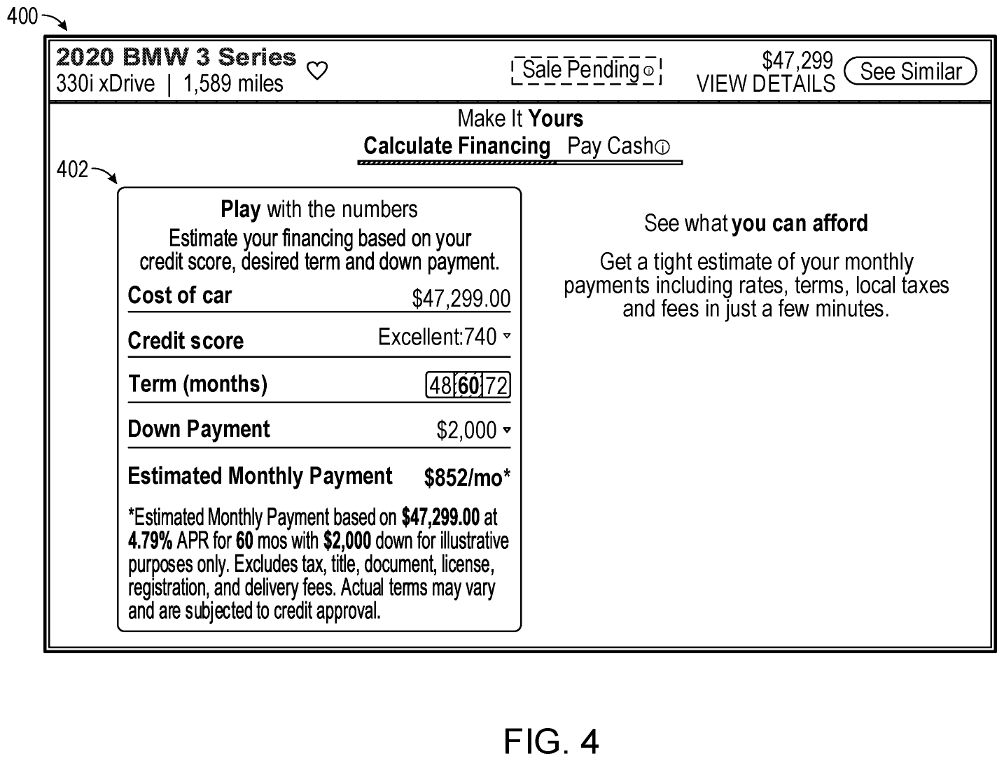

In some embodiments, the systems and methods described herein may allow for personalized recurring payment information to be presented on the user interface for all of the vehicles in the vehicle inventory and all of the financing structures that are available (or a subset of the vehicle inventory and the available financing structures) as follows. A user may access the user interface (for example, through a device such as a desktop, laptop, smartphone, etc.) and browse the vehicle inventory or inventories presented through the user interface (an example of such a user interface is presented in FIGS. 3-4). The user makes a selection of an initial vehicle and financing structure. Based on this (and/or other information, such as information associated with the user, for example), the system determines one or more additional vehicles and associated financing structures. These one or more additional vehicles and associated financing structures may be determined using statistical methods, such as design of experiments, or may be determined through any other method, such as artificial intelligence, machine learning, or the like (at least FIG. 2E provides additional details regarding how these additional vehicles and financing structures are determined). In some cases, the one or more additional vehicles may be other vehicles that are included in the vehicle inventory (or inventories). In some other cases, the one or more additional vehicles may also include vehicles not included in the vehicle inventory (or inventories) as well. Once the initial vehicle and associated financing structure as well as the one or more additional vehicles and associated financing structures are determined, an indication of this information is provided to one or more entities. In some cases, the one or more entities may be lending institutions (in some cases, the term “lending institution(s)” may be used interchanbealy with “one or more entities” herein). However, in some cases, the one or more entities may include any other type of entity. For example, the determinations made by the lending institutions may similarly be performed through local processing. The one or more entities may receive this information and send back financing terms for the vehicles and associated financing structures. For example, for a given vehicle and financing structure, a lending institution may provide an interest rate and recurring payment amount for the vehicle (for example, monthly payment amount). The system may then use this actual data received from the one or more entities in order to determine recurring payment information for the remainder of the vehicle inventory (or inventories).

As one example of this process, the user may initially select (from the user interface) a 2020 BMW 3 Series with a listing price of $47,299, and may select a financing structure including a term length of 60 months and a down payment of $2,000. Based on this initial selection, the system may automatically determine additional vehicles without any additional manual input from the user. For example, the system may determine that a 2015 BMW 335i and a 2018 Audi S5 should be included as additional vehicles. The system may also determine corresponding financing structures associated with the additional vehicles. For example, a term length of 48 months and a down payment of $8,000 and a term length of 60 months and a down payment of $6,000, respectively. The system may then package all of this information and provide it to the one or more entities. Based on this information, the one or more entities may provide one or more financing terms for the vehicle(s) and associated financing structures included within the package. Once the financing terms are received from the one or more lending institution(s), the system may determine payment information that would apply to the remaining vehicles in the vehicle inventory (or a subset of the total vehicle inventory) under different financing structures. These determinations may be made using similar methods used to determine the group of additional vehicles and financing structure (for example, design of experiments, artificial intelligence, machine learning, or the like), or may be determined using different methods. Additional details about how these determinations are performed is provided in FIGS. 2A-2D. In this regard, the system may begin with a single initial vehicle selection, may determine additional vehicles based on this selection, may receive a relatively minimal amount of actual financing term data, and then, using this actual data, may extrapolate the data to the remainder of the vehicle inventory. In some cases, the system may not even require the initial vehicle selection, and may instead rely on other information, such as user demographic information, purchase history, transaction platform search history, etc. In other words, the system may be capable of automatically presenting user-specific recurring payment information for different vehicles and financing structures in real-time or near-real-time while requiring minimal or no manual input from the user.

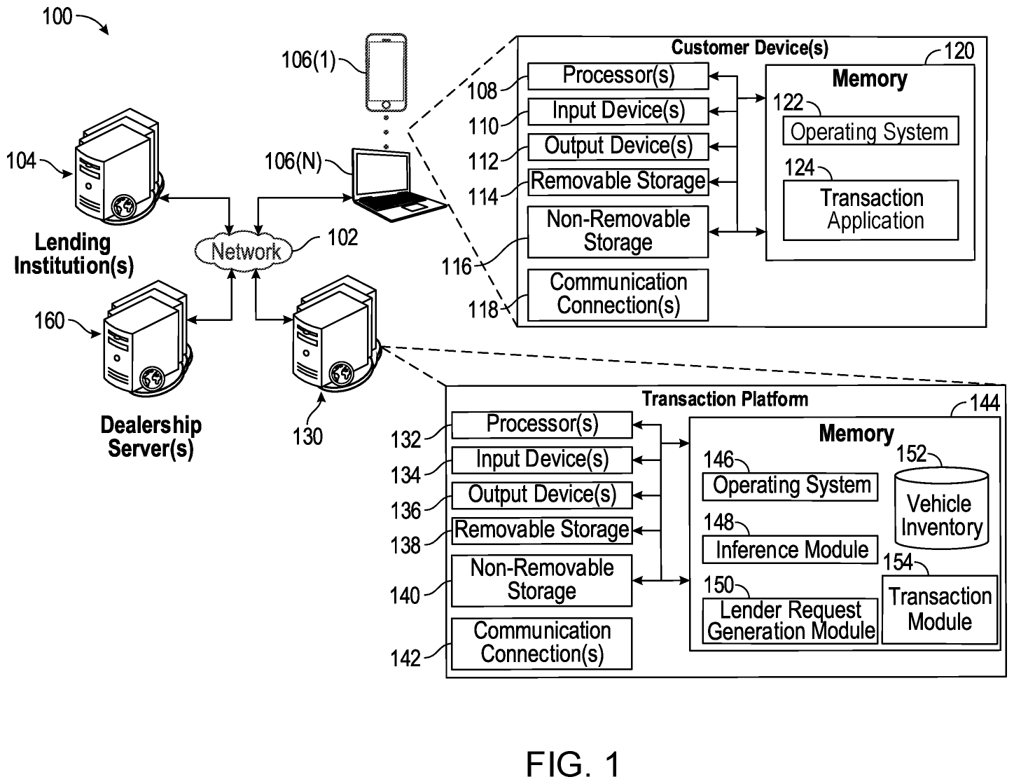

FIG. 1 is a schematic illustration of an example system 100 in accordance with one or more example embodiments of the disclosure. As shown in FIG. 1, the system 100 may include at least one or more user devices 106(1), . . . , 106(N), one or more transaction platforms 130, one or more lending institution(s) 104, and one or more dealership server(s) 160.

In some embodiments, the one or more user devices 106(1), . . . , 106(N) includes portable or non-portable devices, each having computing resources and communication resources that permit sending, receiving, or exchanging data and/or signaling wirelessly with an external electronic device (mobile or otherwise). For instance, the mobile devices can include a mobile telephone (such as, a smartphone), a tablet computer, a wearable, a laptop computer, a gaming console, an electronic reader (e-reader), a user electronics device having wireless communication functionality, a home appliance having wireless communication functionality, a combination thereof, or similar.

In some embodiments, communications between one or more user devices 106(1), . . . , 106(N), one or more transaction platforms 130, one or more lending institutions(s) 104, and one or more dealership server(s) 160 is performed via one or more networks 102, which may be wireless or wired networks. The one or more networks 102 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, the one or more networks may have any suitable communication range associated therewith and may include, for example, global networks (e.g., the Internet), metropolitan area networks (MANs), wide area networks (WANs), local area networks (LANs), or personal area networks (PANs). In addition, the one or more networks includes any type of medium over which network traffic may be carried, including, but not limited to, coaxial cable, twisted-pair wire, optical fiber, a hybrid fiber-coaxial (HFC) medium, microwave terrestrial transceivers, radio frequency communication mediums, white space communication mediums, ultra-high frequency communication mediums, satellite communication mediums, or any combination thereof.

In an illustrative configuration, the one or more user devices 106(1), . . . , 106(N) includes at least a memory 120 and one or more processing units (or processors) 108. The processor(s) 108 may be implemented as appropriate in hardware, software, firmware, or combinations thereof. Software or firmware implementations of the processor(s) 108 may include computer-executable or machine-executable instructions written in any suitable programming language to perform the various functions described.

The memory 120 stores program instructions that are loadable and executable on the processor(s) 108, as well as data generated during the execution of these programs. Depending on the configuration and type of the device, the memory 120 may be volatile (such as, random access memory (RAM)) and/or non-volatile (such as, read-only memory (ROM), flash memory, etc.). The one or more user devices 106(1), . . . , 106(N) may also include additional removable storage 114 and/or non-removable storage 116, including, but not limited to, magnetic storage, optical disks, and/or tape storage. The disk drives and their associated computer-readable media may provide non-volatile storage of computer-readable instructions, data structures, program modules, and other data for the vehicles. In some implementations, the memory 120 includes multiple different types of memory, such as, static random access memory (SRAM), dynamic random access memory (DRAM), or ROM.

The memory 120, the removable storage 114, and the non-removable storage 116 are all examples of computer-readable storage media. For example, the computer-readable storage media includes volatile and non-volatile, removable and non-removable media implemented in any method or technology for the storage of information such as computer-readable instructions, data structures, program modules, or other data. The memory 120, the removable storage 114, and the non-removable storage 116 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the desired information and which can be accessed by a device. Combinations of any of the above should also be included within the scope of computer-readable media.

Alternatively, computer-readable communication media may include computer-readable instructions, program modules, or other data transmitted within a data signal, such as a carrier wave, or other transmissions. However, as used herein, computer-readable storage media does not include computer-readable communication media.

The one or more user devices 106(1), . . . , 106(N) also includes communication connection(s) 118 that allows the one or more user devices 106(1), . . . , 106(N) to communicate with a stored database, another vehicle or server, user terminals, and/or other devices on a network. The one or more user devices 106(1), . . . , 106(N) may also include input device(s) 110 and output device(s) 112, such as a touch screen that is capable of receiving input commands from a user and presenting a user interface to the user.

Turning to the contents of the memory 120 in more detail, the memory 120 includes an operating system 122 and one or more application programs or services for implementing the features disclosed herein, including a transaction application 124. The transaction application allows a user to perform certain functions using the one or more user devices 106(1), . . . , 106(N). For example, the transaction application 124 may allow a user to access the transaction platform 130, browse a vehicle inventory, select individual vehicles to view information about the vehicle, create a listing for sale of a vehicle, select a vehicle for purchase, or perform any other actions capable of being performed on the transaction platform.

In some embodiments, the transaction platform 130 may include some similar elements as the one or more user devices 106(1), . . . , 106(N). That is, the transaction platform 130 may include at least a memory 144 and one or more processing units (or processors) 132. The processor(s) 132 may be implemented as appropriate in hardware, software, firmware, or combinations thereof. Software or firmware implementations of the processor(s) 132 may include computer-executable or machine-executable instructions written in any suitable programming language to perform the various functions described.

The memory 144 stores program instructions that are loadable and executable on the processor(s) 132, as well as data generated during the execution of these programs. Depending on the configuration and type of the transaction platform 130, the memory 144 may be volatile (such as, random access memory (RAM)) and/or non-volatile (such as, read-only memory (ROM), flash memory, etc.). The transaction platform 130 may also include additional removable storage 138 and/or non-removable storage 140, including, but not limited to, magnetic storage, optical disks, and/or tape storage. The disk drives and their associated computer-readable media may provide non-volatile storage of computer-readable instructions, data structures, program modules, and other data for the vehicles. In some implementations, the memory 144 includes multiple different types of memory, such as static random access memory (SRAM), dynamic random access memory (DRAM), or ROM.

The memory 144, the removable storage 138, and the non-removable storage 140 are all examples of computer-readable storage media. For example, computer-readable storage media may include volatile and non-volatile, removable and non-removable media implemented in any method or technology for the storage of information such as computer-readable instructions, data structures, program modules, or other data. The memory 144, the removable storage 138, and the non-removable storage 140 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the desired information and which can be accessed by the transaction platform 130 or other vehicles. Combinations of any of the above should also be included within the scope of computer-readable media.

Alternatively, computer-readable communication media may include computer-readable instructions, program modules, or other data transmitted within a data signal, such as a carrier wave, or other transmissions. However, as used herein, computer-readable storage media does not include computer-readable communication media.

The transaction platform 130 may also contain communication connection(s) 142 that may allow the transaction platform 130 to communicate with a stored database, another vehicle or server, user terminals, and/or other devices on a network. The transaction platform 130 may also include input device(s) 134 such as, a keyboard, a mouse, a pen, a voice input device, a touch input device, etc., and output device(s) 136, such as, a display, speakers, printers, etc.

Turning to the contents of the memory 144 in more detail, the memory 144 includes an operating system 146 and one or more application programs or services for implementing the features disclosed herein, including an inference module 148, a lender request generation module 150, and/or a transaction module 154. In some embodiments, the lender request generation module 150 may be used by the transaction platform 130 to automatically determine one or more additional vehicles and/or financing structures to send to the one or more lending institution(s) 104. Additional details about how these one or more additional vehicle(s) and/or financing structure(s) are determined is presented in at least FIGS. 2A-2E. The inference module 148 may be used by the transaction platform 130 to automatically determine payment information for the remainder of the vehicle inventory (or a subset of the vehicle inventory) once the financing terms are received back from the one or more lending institution(s) 104. Additional details about how this payment information is determined is presented in at least FIGS. 2A-2E. The transaction module 154 may provide functionality associated with the transaction platform, such as presenting the user interface. The memory 144 may also include vehicle inventory 152 information, such as a listing of vehicles included in the inventory, as well as information associated with the vehicles (for example, make, model, year, listing price, mileage, ownership history, etc.). It should be noted that these are just exemplary modules, and the operations described herein may be performed using any number of different types of modules.

In some embodiments, the lending institution(s) 104 and/or dealership server(s) 160 also include similar components as the and/or transaction platform 130 and/or the one or more user devices 106(1), . . . , 106(N) as well. The one or more lending institution(s) 104 receive information from the transaction platform 130, such as data associated with vehicles and/or financing structures, and send back financing terms based on the vehicles and/or financing structures. The one or more dealership server(s) 160 may include vehicle inventory information. In some instances, the vehicle inventory information may be the same vehicle inventory 152 information included with the transaction platform 130. Additionally, it should be noted that while certain descriptions provided herein may indicate that certain operations are performed on the transaction platform 130, any of the operations described herein may be performed at any of the parts of the system 100. For example, while FIGS. 2A-2E describe operations as being performed at the transaction platform 130, however, these operations may similarly be performed at the one or more user devices 106(1), . . . , 106(N) as well.

Program modules, applications, or the like disclosed herein may include one or more software components, including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language is a lower-level programming language, such as an assembly language associated with a particular hardware architecture and/or operating system platform. A software component comprising assembly language instructions may require conversion into executable machine code by an assembler prior to execution by the hardware architecture and/or platform.

Another example programming language is a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database task or search language, or a report writing language. In one or more example embodiments, a software component comprising instructions in one of the foregoing examples of programming languages may be executed directly by an operating system or other software components without having to be first transformed into another form.

A software component may be stored as a file or other data storage construct. Software components of a similar type or functionally related may be stored together, such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines, and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture, including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

FIGS. 2A-2D depict illustrative flow diagrams, in accordance with one or more example embodiments of the present disclosure. As aforementioned, while the flow diagrams associated with FIGS. 2A-2D may specifically describe operations with respect to a transaction platform involving the purchase/sale of vehicles, these same operations may similarly be applied to any other type of item that may be listed for purchase. Beginning with FIG. 2A, flow diagram 200 illustrates a high-level overview of operations that may be performed with respect to the systems and methods described herein. That is, the operations described in the flow diagram 200 may be employed in order to provide a user with personalized payment information for some or all of the vehicles in a vehicle inventory that the user is browsing without the user being required to individually request such information for each vehicle and financing structure combination. For example, the user may be browsing a vehicle inventory on a website that displays the vehicle listings through a user interface (examples of such a user interface may be illustrated in FIGS. 3-4). It should be noted that “vehicle inventory” as used herein refers to an inventory of one dealership, multiple dealerships, private sellers, or any other combination of different vehicles that are owned by any different number of parties (that is, the inventory may not necessarily be limited to just one dealership). Additionally, although the term “web site” is used herein, the user interface may be presented through a mobile device application, or may be presented in any other form as well. The website may present multiple vehicle listings on the user interface such that the user may browse the website and view information about the vehicles that are included in the vehicle inventory (for example, as shown in FIG. 3). For example, through the user interface, a user may be able to view images of the vehicles, details about the vehicle, such as the vehicle trim level, previous ownership details, a number of miles associated with the vehicle, a current listing price of the vehicle, and/or any other types of relevant information. In a conventional system including a user interface presenting this type of information to users, the user interface may provide a user with an option to input a financing structure for a particular vehicle, and based on this financing structure, the system may provide the user with an estimated recurring payment amount for the vehicle based on the provided financing structure. For example, the user may select a 2018 Toyota Corolla with a down payment of $2,000 at an estimated interest rate of 4.5% and a loan term of 60 months. Based on these inputs, the conventional system may be able to provide an estimated monthly payment of approximately $370 per month to the user. While this provides some valuable information to the user, this may ultimately not be the actual monthly payment that the user may be required to pay. It would be beneficial for the user to receive personalized payment information in order to make a more informed purchasing decision. Additionally, under these conventional systems, the user may be required to manually input such information for every vehicle and financing structure for which they desire to receive estimated payment information. This may be overly time-consuming for the user and may result in a poor shopping experience for the user. Finally, additional difficulties may arise if the user does not have a credit score or is associated with a subprime credit score. An alternative option may be for the system to determine estimated payment information for all combinations of vehicles, vehicle configurations, and financing structures that are possible based on the vehicle inventory. However, the amount of time required to perform these computations would be unfeasible. To address this, the high-level flow diagram 200 described below, as well as the systems and methods described herein as a whole, eliminate the need for these manual determinations and allow for actual payment information to be computed and presented to a user in a practical amount of time (in some cases, in real-time) that allows the user to view such information as they browse the vehicle inventory through the user interface.

In some embodiments, the flow diagram 200 begins with operation 202, which may involve receiving a request for payment information for a first vehicle and a first financing structure associated with the first vehicle. Particularly, in some cases, the payment information includes an exact or in some cases, personalized, recurring payment (for example, a monthly payment or any other payment period) that a user may pay for the first vehicle under the first financing structure, rather than an estimated monthly payment. For example, the user may desire to receive exact or personalized monthly payment information for a used 2018 Toyota Corolla in the vehicle inventory if the user were to provide a $2,000 down payment and obtain a loan under a 48-month repayment term. However, this is merely one example, and the vehicle and financing structure may include any other type of vehicle and/or financing structure. For example, the user may also be interested in receiving exact or personalized payment information for a 2021 BMW 3 Series if the user were to provide a $20,000 down payment and obtain a loan under a 36-month repayment term. Additionally, the payment information may not necessarily be limited to just exact monthly payment amounts, but may include any other types of payment information as well, such as a total amount the user will pay for the vehicle over the term of the loan, or any other payment information. This exact or personalized payment information for this initial vehicle and financing structure selected by the user may be determined by sending the vehicle and financing structure to one or more lending institutions (which may also be referred to herein as one or more financing institutions, entities, or the like herein) as may be done in a typical vehicle transaction.

Following operation 202, the flow diagram 200 proceeds to operation 204, which may involve determining that the user does not qualify for traditional financing. For example, the user may not be associated with a credit score, or may have a subprime credit score. A lending institution may not be willing to provide a loan to a user with no or a subprime credit score. This operation may also occur before operation 202, or at any other stage of the flow diagram 200. It may be determined if the user has no credit score or a subprime credit score in any number of different ways. For example, a credit check may be performed for the user by requesting credit information for the user from one or more credit agencies. This information may be determined by providing personal identifying information associated with the user to the one or more credit agencies. However, the credit associated with the user may also be determined using any other suitable method as well.

Following operation 204, the flow diagram 200 proceeds to operation 206, which may involve determining a group of additional vehicles, and also determining financing structures for the group of additional vehicles. As aforementioned, the systems and methods described herein may provide the advantage in that they may be used to provide exact or personalized recurring payment information for a large subset of vehicles in a vehicle inventory or vehicle inventories (and/or all of the vehicles in the vehicle inventory or vehicle inventories) without the user being required to request the payment information for each individual vehicle. That is, operation 206 may involve determining, based on the initial vehicle and financing structure selections made by the user, a subset of additional vehicles and financing structures to also send to lending institutions. In this regard, instead of only sending information associated with the vehicle and financing structure selected by the user, and only receiving one or more financing terms associated with that one vehicle and financing structure, a group of additional vehicles and financing structures may be determined based on the initial user selection, and all of these vehicles and financing structures may be sent to the one or more lending institutions. By doing so, the system may be able to obtain a much larger amount of data relating to actual financing term information from lending institutions for the user rather than simply obtaining data relating to the one specific vehicle and financing structure that the user actually requested. In other words, when the user makes the request for the actual payment information for the vehicle and financing structure, the system may then automatically identify a group of additional vehicles and financing structures to send to one or more financing institutions rather than just sending the vehicle and financing structure actually provided by the user.

In some embodiments, the initial selection of a vehicle and/or a financing structure may not necessarily be required. That is, in some cases, the remaining operations of the flow diagram 200 may be performed even before a user performs a selection of a vehicle and/or a financing structure. In this regard, operation 206 involves determining a group of vehicles, vehicle configurations, and financing structures based on information other than an initial selection. For example, the group of vehicles and financing structures may be determined based on information associated with the user, such as demographic information, historical purchase information, and/or any other relevant information. As another example, the group of vehicles and financing structures may be determined based on search criteria that is input by the user. For example, the user may be browsing the website, including the vehicle inventory, and may input a search for a 2020 BMW 3 Series, but may not actually select a particular vehicle on the user interface. This search criteria in itself may be sufficient for the group of vehicles and financing structures to be determined. Additionally, in some cases, the initial selection may not necessarily be limited to just one vehicle and financing structure. For example, the initial selection may include a combination of multiple vehicles and/or financing structures.

In some embodiments, the group of additional vehicles and financing structures is determined through mechanisms such as artificial intelligence, machine learning, design of experiments, or the like. That is, this group of additional vehicles and financing structures may not necessarily actually be requested by the user, but rather may automatically be determined using any of these mechanisms. Design of experiments may be a statistical technique that may allow the individual and interactive effects of multiple factors that may have an influence on an output to be analyzed simultaneously rather an individually. The data resulting from a design of experiments analysis may be used to build mathematical functions that may represent the relationship between the factors and the measured responses. These equations can be first, second or higher order, depending on how the responses react to changes in the factors. For example, the mathematical functions may be used to determine actual payment information based on certain input information, such as a vehicle type, down payment amount, financing term length, or any other input information that may be used to determine payment information. Additionally, if a machine learning model is used, the machine learning model may be trained to be able to more effectively determine which additional vehicles, vehicle configurations, and/or financing structures to send to the one or more financing institutions. The machine learning model may also be trained to more effectively determine payment information for some or all the remaining vehicles in the vehicle inventory (for example, as described below with respect to operation 210). In some cases, multiple machine learning models may be employed. Additional details about how the group of additional vehicles, vehicle configurations, and financing structures are determined is presented in at least FIGS. 2B-2E.

Following operation 206, the flow diagram 200 proceeds to operation 208, which may involve sending data associated with the first vehicle, the group of additional vehicles, and the multiple financing structures to multiple lending institutions. The data may include an indication of the vehicles and financing structures. The purpose of performing this operation is to allow the system to obtain actual financing terms from the one or more lending institutions for the first vehicle, the group of additional vehicles, and the various financing structures. This actual data may then be used to determine similar actual payment information for some or all of the remaining vehicles in the vehicle inventory not included within this initial first vehicle and group of additional vehicles. That is, by receiving this larger amount of data from the one or more financing institutions, the system may be able to more effectively determine the actual payment information for some or all of the remaining vehicles in the inventory than if only information for the initially selected vehicle and financing structure were to be obtained. Following operation 208, the flow diagram 200 proceeds to operation 210, which may involve receiving financing terms from the various financial institutions for the vehicles and the various financing structures. In some cases, a matrix of information is generated based on the financing terms received from the various financial institutions. The matrix may include the one or more financial institutions and the offers received from the one or more financial institutions, as well as the information that was provided to the one or more financial institutions that led to the particular terms. For example, a first financial institution may return an interest rate of 4.75% based on receiving a request for a rate for a 2015 Honda Accord worth $13,000 for a financing structure, including a down payment of $1,000 and a term length of 60 months. This information, as well as any other information received from any other financial institutions, may be included within this matrix. An example of such a matrix is provided in FIG. 2D. The information included within the matrix may then be used in operation 212, described below. Additionally, while it is described above that the information is used to generate a matrix, the information may be packaged in any other form, such as entries in a database.

Following operation 210, the flow diagram 200 proceeds to operation 212, which may involve determining the actual payment information for some or all the remaining vehicles in the vehicle inventory based at least on the various financing offers received from the one or more financing institutions. In some cases, determining the actual payment information may involve inferring the actual payment information. In some cases, determining the actual payment information for some or all of the remaining vehicles may also be determined through mechanisms such as artificial intelligence, machine learning, design of experiments, or the like. That is, actual payment information for some or all of the remaining vehicles may automatically be determined using any of these mechanisms. Additional details about how actual payment information for some or all of the remaining vehicles may be determined is presented in at least FIG. 2C.

Following operation 212, the flow diagram 200 proceeds to operation 214, which involves presenting the determined payment information for all of the vehicles, vehicle configurations, and financing structures that were determined in operations 202-212. An example of a user interface presenting this information is provided in FIGS. 3-4. In this manner, the systems and methods described herein may provide for an improved user interface that may allow for more effective vehicle browsing by users. This is because the user interface may allow the user to view information about multiple vehicles, including actual payment information that is customized to that user, without having to manually select every vehicle on the user interface, and input specific parameters, such as down payment amount, term length, etc. in order to determine actual payment information for a vehicle presented through the user interface. This drastically improves browsing efficiency for the user.

FIG. 2B illustrates another flow diagram 215, in accordance with one or more example embodiments of the present disclosure. The flow diagram 215 provides additional details relating to operation 206 of the flow diagram 200. That is, the flow diagram 215 may provide additional details about how the group of additional vehicles and financing structures may be determined to be provided to the lending institution(s). In some cases, the group of additional vehicles and financing structures may be determined by transaction platform 130. However, the group of additional vehicles and financing structures may be determined by any other system described herein (for example, the user device(s) 106(1) . . . 106(N) or any other system present at any geographic location). In order to determine the group of additional vehicles and financing structures, the transaction platform 130 may receive any number of different types of information as inputs 216. For example, the transaction platform 130 may receive selected vehicle(s) information and/or selected financing structure(s) (for example, financing structure(s) associated with the selected vehicle(s)). As mentioned above, a user browsing a user interface associated with the transaction platform 130 may be browsing different vehicle listings associated with one or more vehicle inventories. The user may make an initial selection of a vehicle by selecting one of the listings on the user interface. For example, the user may select a listing associated with a 2021 Honda Accord. The user may also select any other number of vehicles as well. Additionally, the user may select one or more financing structures associated with the one or more selected vehicles. That is, the user may select one or more financing term lengths, down payments, and/or any other information associated with a financing structure. For example, the user may select a term length of 48 months and a down payment of $5,000 for the 2021 Honda Accord. This information may be used as an input 216 in FIG. 2B in order to determine the group of additional vehicles and financing structures. Additionally, the inputs 216 may include information associated with the user. For example, the information may include demographic information, a prior vehicle purchase history, a residential address of the user, and/or any other information. The inputs 216 may also include any other information beyond the selected vehicle(s) information, the selected financing structure(s), and/or the information associated with the user.

In some embodiments, the one or more additional vehicle(s) and/or financing structure(s) may be determined using design of experiments, artificial intelligence, machine learning, or the like. Design of experiments is a statistical technique that allows the individual and interactive effects of multiple factors that have an influence on an output to be analyzed simultaneously rather an individually. The data resulting from a design of experiments analysis may be used to build mathematical functions that represents the relationship between the factors and the measured responses. These equations can be first, second, or higher-order, depending on how the responses react to changes in the factors. For example, the mathematical functions may be used to determine actual payment information based on certain input information, such as a vehicle type, down payment amount, financing term length, or any other input information that is used to determine payment information. Additionally, if a machine learning model is used, the machine learning model may be trained to be able to more effectively determine which additional vehicles, vehicle configurations, and/or financing structures to send to the one or more financing institutions. The machine learning model may also be trained to more effectively determine payment information for some or all the remaining vehicles in the vehicle. In some cases, multiple machine learning models may be employed.

In some embodiments, the outputs 220 of the flow diagram 215 may include the one or more additional vehicle(s) and/or the one or more additional financing structure(s). That is, the outputs 220 may include one or more additional vehicle(s) and/or one or more additional financing structure(s) that may be provided to the one or more lending institution(s) along with the initially-selected vehicle and/or financing structure indicated by the user. For example, the user may initially select a 2020 Honda Accord and may indicate a financing structure including a term length of 60 months and a down payment of $4,500. This selection may be provided as an input 216 to the transaction platform 130. Based on this, the transaction platform 130 may provide as outputs 220 an indication of a 2019 Honda accord and an associated financing structure including a term length of 60 months and a down payment of $4,000 and an indication of a 2017 Toyota Corolla and an associated financing structure including a term length of 48 months and a down payment of $3,000. In some cases, the vehicle(s) included in the outputs 220 are the same as the selected vehicle provided as the input 216. In some cases, the financing structure(s) included in the outputs 220 are the same as the financing structure(s) provided as the input 216. However, in some cases, the vehicle(s) and/or financing structure(s) may be different as well.

FIG. 2C illustrates another flow diagram 221, in accordance with one or more example embodiments of the present disclosure. The flow diagram 215 provides additional details relating to operations 208-212 of the flow diagram 200. That is, the flow diagram 221 provides additional details about how the payment information for some or all of the remaining vehicles in the vehicle inventories is determined. The flow diagram 221 begins with providing information (for example, inputs 222) to one or more lending institution(s) 104. The inputs 222 may include information obtained from the flow diagram 215. For example, the inputs 222 may include selected vehicle(s) information, selected financing structure(s), additional vehicle(s), additional financing structure(s), and/or any other information. That is, the transaction platform may provide the initially-selected vehicle and financing structure to the one or more lending institutions(s) 104 as well as the determined additional vehicle(s) and financing structure(s). Subsequent to receiving these inputs 222, the one or more lending institution(s) 104 may provide one or more outputs 226. The one or more outputs 226 may be in the form of financing terms associated with the selected vehicle(s) information, selected financing structure(s), additional vehicle(s), additional financing structure(s). These one or more outputs 226 may be provided back to the transaction platform 130.

In some embodiments, after receiving the financing terms in the form of the one or more outputs 226, the transaction platform 130 may use this information in order to produce one or more outputs 230. The one or more outputs 230 may include payment information for some or all of the remaining vehicles in the vehicle inventories based on any number of different financing structures. That is, the transaction platform may utilize the actual financing terms received from the one or more lending institution(s) 104 in order to extrapolate financing terms for any vehicles in the vehicle inventory that were not included in the inputs 222 provided to the lending institution(s) 104. By doing so, the transaction platform may be able to provide actual payment information associated with a larger number (or all) of the vehicles in the vehicle inventory in association with various financing terms without having to provide all of the vehicle and financing term combinations to the lending institution(s) 104.

In some embodiments, the transaction platform 130 may determine the one or more outputs 230 using some or all of the same methods described with respect to the flow diagram 215 of FIG. 2B. That is, the transaction platform may employ design of experiments, artificial intelligence, machine learning, or the like. However, in some cases, the methods used with respect to flow diagram 215 may differ from the methods used with respect to flow diagram 221. That is, the methods used to determine the one or more additional vehicle(s) and/or financing structure(s) to provide to the lending institution(s) 104 may differ from the methods used to determine the payment information for some or all of the remaining vehicles in the vehicle inventories once the financing terms are received back from the one or more lending institution(s) 104.

FIG. 2D illustrates another flow diagram 250, in accordance with one or more example embodiments of the present disclosure. The flow diagram 250 may provide one example visual representation of a use case associated with the operations described herein. The flow diagram 250 begins with operation 260, which may involve a user performing an initial selection of a vehicle 256 and/or a financing structure 258. For example, the user may select a 2020 BMW 3 Series with a listing price of $47,299 as the vehicle 256, and may select a financing structure 258 including a term length of 60 months and a down payment of $2,000. The user may also indicate a credit score of 740. The flow diagram 250 also illustrates that a matrix 270 may be generated based on the selection of the vehicle 256 and the financing structure 258. As shown in the figure, the matrix 270 may include the make, model, and year of the vehicle 256, the listing price of the vehicle, and the financing structure 258 indicated by the user. This is only one example of types of information that could be included in the matrix 270, and any other types of information can be included.

From operation 260, the flow diagram 250 proceeds to operation 262, which may involve determining one or more additional vehicle(s) and or financing structure(s) based on the initial selection of the vehicle 256 and financing structure 258 as performed in operation 260. That is, operation 262 corresponds to flow diagram 215 of FIG. 2B, and/or operation 206 of FIG. 2A. The figure also illustrates that these additional vehicles and/or financing structures are added to the matrix 270, which is depicted as matrix 272. For example, the additional vehicles may include a 2015 BMW 335i and a 2018 Audi S5, and the corresponding financing structures may include a term length of 48 months and a down payment of $8,000 and a term length of 60 months and a down payment of $6,000, respectively.

Once the additional vehicle(s) and financing structure(s) are determined, the selected vehicle(s) information, selected financing structure(s), additional vehicle(s), additional financing structure(s) may be provided to the one or more lending institution(s) 104 in operation 264. That is, the information included in matrix 272 (and/or any other information) may be provided to the one or more lending institution(s) 104. Based on this information, and at operation 266, the one or more lending institution(s) 104 may provide one or more financing terms associated with the vehicle(s) and associated financing structures provided to the one or more lending institution(s) 104. This may be represented by the matrix 274, which also includes interest rate information and monthly payment information.

Finally, once the financing terms are received from the one or more lending institution(s) 104 in operation 268, the transaction platform 252 may determine payment information that would apply to some or all of the remaining vehicles in the vehicle inventories given different financing structures. This is depicted in the example matrix 276. For the sake of the example use case presented in FIG. 2D, it is assumed that the total vehicle inventory includes the six vehicles included in the matrix 276. As depicted in the matrix 276, based on the financing terms provided by the one or more lending institution(s) 104 for the vehicles and financing structures included in the matrix 272, the transaction platform 252 may determine payment information for the remaining two vehicles included in the vehicle inventory. The payment information may be determined for a vehicle for multiple different combinations of financing structures. For example, the matrix 276 may depict a 2020 BMW 330i having a determined interest rate of 3.7% and a recurring payment amount of $1,017 for a financing structure including a term length of 48 months and a down payment of $2,000. The matrix 276 may also depict that for the same 2020 BMW 330i, an interest rate of 5% and a recurring payment amount of $730 may apply to a financing structure including a term length of 72 months and a down payment of $2,000.

FIG. 2E depicts example selection criteria for a representative group of vehicles, in accordance with one or more example embodiments of the present disclosure.

Particularly, FIG. 2E provides additional details regarding how a subset of vehicles in an overall vehicle inventory is selected to provide to the one or more lending institution(s) (for example, operation 262 shown in FIG. 2D). The figure shows a matrix 280 including various metrics associated with nine different vehicles included in an example vehicle inventory (a vehicle inventory may also include any other number of vehicles). For example, the matrix 280 shows a first metric 281 including a vehicle price range, a second metric 282 including a vehicle mileage range, a third metric 283 including a year range, and a fourth metric 284 including a number of cylinders in an engine of the vehicle. It should be noted that while the matrix 280 shows four different vehicle metrics, any other number of metrics may also be considered as well. Additionally, any other metrics may be used in place of the metrics shown in the figure.

Also as shown in the matrix 280, the different metrics may be associated with different value ranges. For example, the price range metric is shown as including price ranges of 10,000 to 17,000, 18,000 to 26,000, 33,000 to 41,000, and 50,000 to 60,0000. The value ranges shown in the matrix 280 are merely exemplary and are not intended to be limiting in any way. The ranges of values associated with each of these metrics may be established in any number of different ways. For example, the ranges may be manually pre-established by a user. As another example, the ranges may be automatically generated by a machine learning model and/or any other type of model.

In one or more embodiments, the vehicle inventory and/or deal attributes may be classified or clustered into different segments based on an unsupervised machine learning clustering algorithm (for example, K-means clustering). However, any other type of machine learning model may also be used as well. To train such a clustering algorithm, historical data may be leveraged, which may provide a large number of example deals that already occurred. From this historical data, vehicle attributes (for example, make, model, mileage etc.) may be used along with deal attributes (for example, down payment amount, term etc.) to curate the model. The model may also receive any other number of different types of inputs. For example, the model may also receive previously-received rate information from the lending institutions, consumer information, such as demographic information and geographical information, and/or any other types of input data. Once the model is trained, the trained model may then be used to cluster a given vehicle inventory for a given user input on deal terms. Based on the output of the model, a representative subset of the vehicle inventory may be selected from each cluster to be submitted to the lending institutions.

In one or more embodiments, the sizes of the value ranges for the different metrics may also be selected so as to prevent the ranges from being too broad or too narrow. A value range that is too broad may result in payment information predictions that are not as accurate. For example, a price range of 50,000 may encompass a large number of vehicles. If only one representative vehicle is selected from this range to provide to the lending institution(s), the payment information received from the lending institution(s) may not necessarily be accurate for all of the other vehicles in this broad range of prices. Likewise, establishing value ranges that are too narrow may result in increased data processing requirements associated. For example, using a price range of 1,000 may result in a larger number of vehicles being provided to the lending institution(s) and processed by the machine learning model to perform predictions for other vehicles in the vehicle inventory. While this may provide added data granularity and prediction accuracy, the processing requirements may be increased.

The size of the ranges may be established manually or automatically based on any number of different criteria. In some instances, the sizes of the value ranges may depend on the distribution of values associated with a particular metric within a given vehicle inventory. For example, the ranges established for a price range metric for a vehicle inventory including a large number of vehicles listed at relatively similar prices may include more narrow ranges. A narrow range may be used to provide more granular payment information predictions. In contrast, a vehicle inventory including vehicles with a larger distribution of different prices may involve the use of broader ranges. However, this is merely one example approach for establishing the value ranges, and the ranges may also be established in any other manner. Continuing the first example in which the majority of the vehicle inventory resides within one narrow price range, broader price ranges may still be used such that most or all of the vehicles fall within a single price range. The example of establishing more narrow price ranges for that specific use case is merely exemplifying the dynamic nature of the range values for the different metrics. That is, the ranges may be established irrespective of the vehicles included in the vehicle inventory as well.

In one or more embodiments, the subset of vehicles selected to provide to the lending institution(s) may be determined based on similarities and/or differences between the metrics associated with the vehicles. For example, the metrics associated with vehicle 1 shown in the matrix 280 are the same as the metrics associated with vehicle 2. Thus, the machine learning model may only select one of vehicle 1 and vehicle 2 to provide to the lending institution(s) in the representative group of vehicles. Continuing this example, if information associated with vehicle 1 is provided to the lending institution(s) and the lending institution(s) then provide payment information for vehicle 1, the machine learning model may then be trained using this information from the lending institution(s). The trained machine learning model may then be used to predict the payment information for vehicle 2. Thus, the amount of actual payment information that is required to be obtained from the lending institution(s) is reduced.

Although this example includes two different vehicles with the same values for each of the different metrics listed in the matrix 280, this is not intending to be limiting. That is, one vehicle may not be included in the representative group of vehicles provided to the lending institution(s) even if it does not include all of the same values for all of the metrics as one of the vehicles selected to be included in the representative group of vehicles. For example, vehicle 4 and vehicle 5 may have the same values for the price range metric, the mileages metric, and the cylinders metric, but may be associated with different year ranges. Regardless, the machine learning model may determine that there is a sufficient level of similarity between vehicle 4 and vehicle 5 that only one of vehicle 4 and vehicle 5 needs to be provided to the lending institution(s). For example, if vehicle 4 is provided to the lending institution(s), payment information for vehicle 5 may then be predicted by the machine learning model based on the actual payment information provided by the lending institution(s) for vehicle 4.

Given that the vehicles may be associated with a large number of metrics indicating various types of information about the vehicles (and/or potential financing structures and financing information), the metrics may be weighted to determine which of the metrics are considered and/or more heavily considered by the machine learning algorithm when the machine learning model selects the representative group of vehicles to provide to the lending institution(s). For example, as shown in the figure, the machine learning model may have determined that the price range, mileage range, year range, and number of cylinders are the highest weighted metrics.

Additionally, the weightings prescribed to the various metrics may not necessarily be static, but rather may be dynamically adjusted as additional data points are obtained from the lending institution(s). For example, based on data provided by the lending institutions (such as actual interest rates for a given vehicle and financing structure), the machine learning algorithm may determine in real-time the relative importance of various types of metrics in the data provided by the lending institution. For example, the machine learning algorithm may determine that a a vehicle's mileage may have a greater impact on an interest rate provided by a lending institution than the make of the vehicle. Given this, the machine learning model may automatically adjust metric weightings such that the representative vehicles are selected based on mileage data rather than vehicle make data.

In addition to providing vehicle information to the lending institution(s), a combination of different financing structures may also be selected to cover multiple potential financing options. This information may also be provided to the lending institution(s) along with the vehicle information. For example, rather than simply providing information about a 2004 Honda Accord to the lending institution(s), multiple financing structures may also be provided as well. For example, a 10% down payment on a 48 month payment plan, a 15% down payment on a 36 month payment plan, and/or any other combinations of financing structures. In this manner, actual payment information (interest rates, etc.) may be provided by the lending institution(s) for different financing structures for the same vehicle rather than only providing actual payment information for one specific financing structure. Thus, actual and predicted payment information for a range of financing structures may also be presented to the user as well.

Once actual payment information is provided by the lending institution(s) for the representative subset of the vehicles and/or financing structures, this information may then be used to train the machine learning model. The trained machine learning model may then utilized to extrapolate and predict payment information (and/or any other types of relevant information) for some or all of the remaining vehicles in the vehicle inventory. Given that the training data covers different deal structure combinations and vehicle types along with actual lender payment information, a pattern is provided which is may then be used to determine predicted payment information for those lending institution(s) for the remainder of the vehicle inventory using the machine learning models.

FIG. 3 depicts an illustrative user interface 300, in accordance with one or more example embodiments of the present disclosure. This illustrative user interface 300 may be representative of a user interface that may be found on the transaction platform. As aforementioned, for consistency sake, the user interface may be described as being associated with vehicles, however, any other item may similarly apply. In some cases, the user interface 300 may allow a user to browse vehicle listings for vehicles that are for sale for purchase. The example user interface 300 may include at least a search filter section (not shown) and various vehicle listings (for example, a first vehicle listing 302, a second vehicle listing 304, and/or any other number of vehicle listings). The search filter section 301 may allow the user to select different search criteria that may then be used to filter the results shown in the form of the vehicle listings. For example, the user may select a particular make and model of a vehicle, a year range, a list price range, a mileage range, or any other parameters that may be used to filter vehicle listings. Using the example vehicle listings presented in the figure, if the user were to select a BMW 3 series as the vehicle make and model through the search filter section 301, then the first vehicle listing 302 for the Dodge Challenger would no longer be presented on the user interface 300. The vehicle listings may present to the user a list of vehicles available for purchase that meet the filter criteria selected by the user. An individual vehicle listing may present to the user a number of different types of information that the user may quickly reference as they scroll through the vehicle listings. For example, a vehicle listing may include one or more images and/or videos of the particular vehicle. The vehicle listing may also include textual information about the vehicle, such as the make, model, and year of the vehicle, the mileage of the vehicle, and a listing price of the vehicle.

One advantage provided by the user interface 300 described herein is that a given vehicle listing may also present actual or personalized payment information. This contrasts with typical vehicle transaction platforms, which may only have the capability to provide estimated payment information for the vehicle. While such estimated information may assist the user in making a more informed decision about a vehicle purchase, the actual amount the user may be responsible to pay may be different than this estimated amount. Additionally, oftentimes to even receive this estimated payment information, the user may be required to select one of the vehicle listings and manually input a financing structure. For example, the user may be required to select a particular vehicle and enter a credit score range, a term length, and a down payment amount. With this being the case, however, the user would need to repeat this manual process for every vehicle and financing structure for which the user desires to view estimated payment information. The user interface 300, and systems and methods associated with the user interface 300 as described herein, however, allow actual or personalized payment information to be presented in the vehicle listings, such that this information is quickly available to the user in order to increase the efficiency and convenience of their vehicle browsing process.

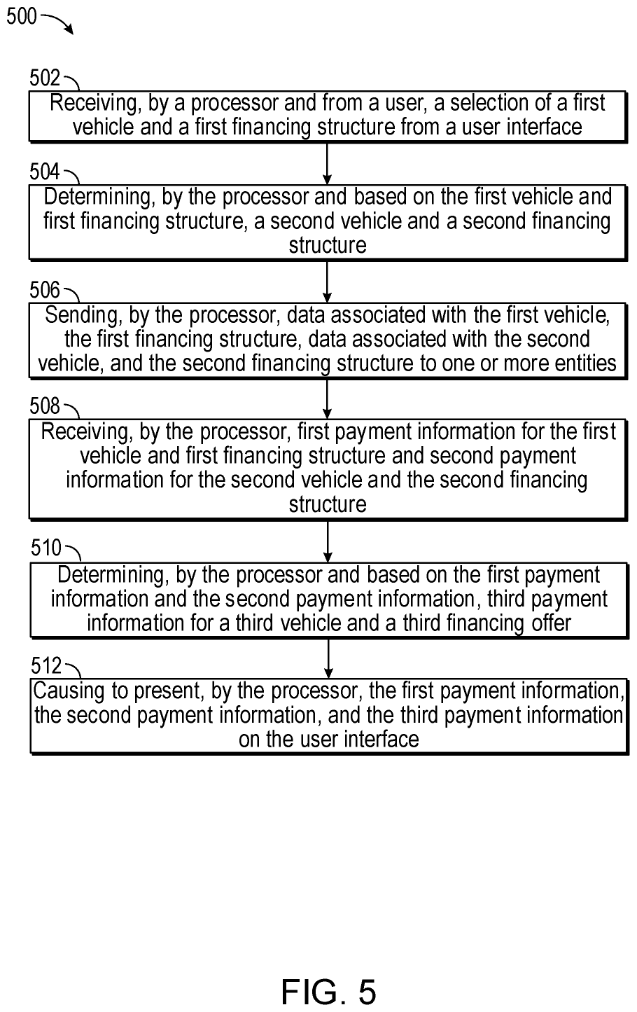

In some cases, the actual payment information is presented along with the individual vehicle listings when the user initially accesses the vehicle transaction platform. For example, the actual payment information may be determined based on information associated with the user, such as historical purchase information, demographic information, credit score information, and/or any other relevant information. However, in some cases, the vehicle listings may initially only include estimated payment information and/or no payment information, and may be updated to include the actual payment information upon the user selecting a particular vehicle and financing structure (for example, as described in the flow diagrams of FIGS. 2A-2D and FIG. 5, for example). Additionally, in some cases, the vehicle listings may include multiple payment information listings. That is, an individual vehicle listing may present actual payment information for various financing structures as opposed to the one actual payment information listing associated with the one financing structure as depicted in the figure. For example, instead of the vehicle listing 302, including only actual payment information for the Dodge Challenger associated with a financing structure, including a $1,000 down payment and a term length of 60 months, the vehicle listing 302 may also present actual payment information for a financing structure including a $2,000 down payment and a term length of 48 months, or any other combination of different types of financing structures as well. The actual payment information that is presented may also be updated based on one or more conditions. For example, as described above, the vehicle listings may initially present estimated payment information and may update to actual payment information based on a user selection of a vehicle and financing structure as described in the flow diagrams of FIGS. 2A-2D and FIG. 5 (for example). As another example, if only one payment information listing is presented as shown in the figure, the payment information listing may be updated based on user interaction with the user interface. For example, the user may indicate that they desire to view actual payment information for a different financing structure, including a different down payment and/or term length. As another example, the actual payment information may update based on a determination that a different user than the initial user is interacting with the user interface. For example, if a first user is browsing the vehicle listings through a user account, and then a second user logs into the vehicle transaction platform to browse the vehicle listings, then the actual payment information may update to represent actual payment information associated with the second user instead of the first user. As another example, the actual or personalized payment information may be updated over time as the user interacts with the vehicle transaction platform for a longer period of time. That is, if the actual payment information is determined according to the operations described with respect to the flow diagrams of FIGS. 2A-2D and FIG. 5 (for example), then if the user manually requests additional financing offers beyond just the initial selection, then the system may have additional data points to use in association with the inferences made for some or all of the remainder of the vehicle inventory. This may result in the actual or personalized payment information being updated, and the actual or personalized payment information lists on the user interface being adjusted to reflect these updates. Additionally, the mechanism used to perform the inferences may be improved over time (for example, a machine learning model may be continuously trained as more data is obtained).

FIG. 4 depicts an illustrative user interface 400, in accordance with one or more example embodiments of the present disclosure. The user interface 400 provides an example of a user interface that a user may utilize in order to specify a desired financing structure. For example, as shown in the section 402 of the user interface, the user may input a credit score, a loan term, and a down payment amount. In the particular example presented in the figure, the financing structure is for a 2020 BMW 3 Series with a listing price of $47,299. The user input a credit score of 740, a term length of 60 months, and a down payment of $2,000. This may be an example of an initial financing structure provided by a user.

FIG. 5 depicts a flow diagram of an illustrative method 500, in accordance with one or more embodiments of the disclosure. At block 502, the method 500 may include receiving, by a processor and from a user, a selection of a first vehicle from a user interface. At block 504, the method 500 may include determining, by the processor and based on the first vehicle, a second vehicle. At block 506, the method 500 may include sending, by the processor, data associated with the first vehicle and data associated with the second vehicle to one or more entities. At block 508, the method 500 may include receiving, by the processor, first payment information for the first vehicle and second payment information for the second vehicle. At block 510, the method 500 may include determining, by the processor and based on the first payment information and the second payment information, third payment information for a third vehicle. At block 512, the method 500 may include causing to present, by the processor, the first payment information, the second payment information, and the third payment information on the user interface.

In some embodiments, the user interface may be associated with any of the systems described with respect to FIG. 1 (as well as any other system). For example, a user may view the user interface through a display of a user device 106(1) . . . 106(N), the transaction platform 130, etc. In some cases, the information that is presented on the user interface may be determined locally to the particular system that it is presented on. For example, if the user interface is presented on a user device 106(1) . . . 106(N), then the processing required to present the information on the user interface may be performed at the user device 106(1) . . . 106(N). In some cases, however, this processing may be performed remotely, and the remote system may send an indication of the information to present on the user interface. For example, if the user interface is associated with a user device 106(1) . . . 106(N), the transaction platform 130 may perform the processing and may send to the user device 106(1) . . . 106(N) an indication of the information to present on the user interface. In some cases, the processing may occur both locally and remotely. These are just examples of how information may be presented on a user interface, and the information may similarly be presented in any other manner.

In some embodiments, determining the second vehicle and the second financing structure is further based on information associated with the user. In some embodiments, wherein inferring the third payment information is based on machine learning, and wherein the method further comprises training a machine learning model based on the first financing offer and the second financing offer. In some embodiments, the first vehicle, second vehicle, and third vehicle are included within a vehicle inventory, and wherein the method further comprises inferring, by the processor and based on the first financing offer and the second financing offer, payment information for all remaining vehicles included within the vehicle inventory.

In some embodiments, the method 500 may also include populating a matrix, including the first vehicle, first financing structure, second vehicle, second financing structure, first financing offer, and second financing offer. In some embodiments, the method 500 may also include determining, by the processor, that the user is associated with a subprime or no credit score. In some embodiments, the method 500 may also include presenting, by the processor and on the user interface, initial payment information at a time prior to presenting the first payment information, the second payment information, and the third payment information. In some embodiments, presenting the first payment information, the second payment information, and the third payment information on the user interface further comprises updating the initial payment information.

It is understood that the above descriptions are for purposes of illustration and are not meant to be limiting.

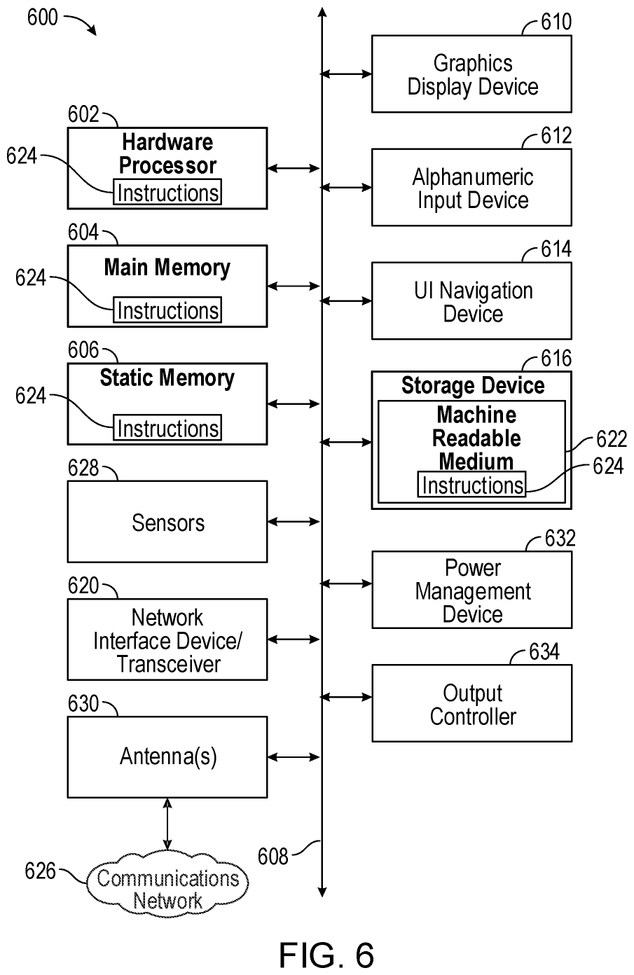

FIG. 6 depicts a block diagram of an example machine 600 upon which any of one or more techniques (e.g., methods) may be performed, in accordance with one or more example embodiments of the present disclosure. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (not shown) (e.g., a speaker), a work assessment device 619 (not shown), a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 616 may include a machine-readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

While the machine-readable medium 622 is illustrated as a single medium, the term “machine-readable medium” may include a single medium, or multiple media (e.g., a centralized or distributed database, and/or associated caches and servers) configured to store the one or more instructions 624. The instructions 624 may be used to perform any of the operations described herein (for example, with respect to FIGS. 2A-2D, 5, or otherwise).

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a user device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple-input multiple-output (MIMO) transceiver or device, a single-input multiple-output (SIMO) transceiver or device, a multiple-input single-output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth-generation (5G) mobile networks, 3GPP, long term evolution (LTE), LTE advanced, enhanced data rates for GSM Evolution (EDGE), or the like. Other embodiments may be used in various other devices, systems, and/or networks.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

What is claimed is:

1. A method comprising:
receiving, by a processor and from a user, a selection of a first vehicle from a user interface;
determining, by the processor and based on the first vehicle, a second vehicle;
sending, by the processor, data associated with the first vehicle and data associated with the second vehicle to one or more entities;
receiving, by the processor, first payment information for the first vehicle and second payment information for the second vehicle;
determining, by the processor and based on the first payment information and the second payment information, third payment information for a third vehicle; and
causing to present, by the processor, the first payment information, the second payment information, and the third payment information on the user interface.

2. The method of claim 1, wherein determining the second vehicle, is further based on information associated with the user.

3. The method of claim 1, wherein determining the third payment information is based on machine learning, and wherein the method further comprises training a machine learning model based on the first payment information and the second payment information.

4. The method of claim 1, wherein determining the third payment information is based on design of experiments, and wherein the method further comprises:
populating a matrix including the data associated with the first vehicle, the data associated with the second vehicle, the first payment information, and the second payment information.

5. The method of claim 1, further comprising:
determining, by the processor, that the user is associated with a subprime or no credit score.

6. The method of claim 1, wherein the first vehicle, second vehicle, and third vehicle are included within a vehicle inventory, and wherein the method further comprises determining, by the processor and based on the first payment information and the second payment information, payment information for all remaining vehicles included within the vehicle inventory.

7. The method of claim 1, further comprising:
causing to present, by the processor and on the user interface, initial payment information at a time prior to presenting the first payment information, the second payment information, and the third payment information,
wherein presenting the first payment information, the second payment information, and the third payment information on the user interface further comprises updating the initial payment information.

8. A system comprising:
a computer processor operable to execute a set of computer-executable instructions; and
memory operable to store the set of computer-executable instructions operable to:
receive, from a user, a selection of a first vehicle from a user interface;
determine, based on the first vehicle, a second vehicle;
send data associated with the first vehicle and data associated with the second vehicle to one or more entities;
receive first payment information for the first vehicle and second payment information for the second vehicle;
determine, based on the first payment information and the second payment information, third payment information for a third vehicle; and
cause to present the first payment information, the second payment information, and the third payment information on the user interface.

9. The system of claim 8, wherein determining the second vehicle, is further based on information associated with the user.

10. The system of claim 8, wherein determining the third payment information is based on machine learning, and wherein the computer-executable instructions are operable to train a machine learning model based on the first payment information and the second payment information.

11. The system of claim 8, wherein determining the third payment information is based on design of experiments, and wherein the computer-executable instructions are operable to:
populate a matrix including the data associated with the first vehicle, the data associated with the second vehicle, the first payment information, and the second payment information.

12. The system of claim 8, wherein the computer-executable instructions are operable to:
determine that the user is associated with a subprime or no credit score.

13. The system of claim 8, wherein the first vehicle, second vehicle, and third vehicle are included within a vehicle inventory, and wherein the computer-executable instructions are operable to determine, based on the first payment information and the second payment information, payment information for all remaining vehicles included within the vehicle inventory.

14. The system of claim 8, wherein the computer-executable instructions are further operable to:
cause to present, on the user interface, initial payment information at a time prior to presenting the first payment information, the second payment information, and the third payment information,
wherein presenting the first payment information, the second payment information, and the third payment information on the user interface further comprises updating the initial payment information.

15. A non-transitory computer-readable medium storing computer-executable instructions, that when executed by at least one processor, cause the at least one processor to perform operations of:
receiving, from a user, a selection of a first vehicle from a user interface;
determining, based on the first vehicle, a second vehicle;
sending data associated with the first vehicle and data associated with the second vehicle to one or more entities;
receiving first payment information for the first vehicle and second payment information for the second vehicle;
determining, based on the first payment information and the second payment information, third payment information for a third vehicle; and
causing to present the first payment information, the second payment information, and the third payment information on the user interface.

16. The non-transitory computer-readable medium of claim 15, wherein determining the second vehicle is further based on information associated with the user.

17. The non-transitory computer-readable medium of claim 15, wherein determining the third payment information is based on machine learning, and wherein the computer-executable instructions further cause the at least one processor to perform operations of training a machine learning model based on the first payment information and the second payment information.

18. The non-transitory computer-readable medium of claim 15, wherein determining the third payment information is based on design of experiments, and wherein the computer-executable instructions further cause the at least one processor to perform operations of:
populating a matrix including the data associated with the first vehicle, the data associated with the second vehicle, the first payment information, and the second payment information.

19. The non-transitory computer-readable medium of claim 15, wherein the computer-executable instructions further cause the at least one processor to perform operations of:
determining that the user is associated with a subprime or no credit score.

20. The non-transitory computer-readable medium of claim 15, wherein the first vehicle, second vehicle, and third vehicle are included within a vehicle inventory, and wherein the computer-executable instructions further cause the at least one processor to perform operations of determining, based on the first payment information and the second payment information, payment information for all remaining vehicles included within the vehicle inventory.
